(19) United States
(12) Patent Application Publication
(10) Pub. No.: US 2008/0078673 A1
(43) Pub. Date: Apr. 3, 2008

(54) ELECTRODE FOR USE IN A DEIONIZATION APPARATUS AND METHOD OF MAKING SAME AND REGENERATING THE SAME

(75) Inventors: Brian Elson, Pueblo, CO (US); Brian C. Large, Pueblo, CO (US); Peter Norman, Pueblo West, CO (US); Richard L. Hoover, Pueblo, CO (US)

Correspondence Address: DARBY & DARBY P.C., P.O. BOX 770, Church Street Station, New York, NY, 10008-0770, US

(73) Assignee: The Water Company LLC, Pueblo, CO (US)

(21) Appl. No.: 11/861,487

(22) Filed: Sep. 26, 2007

Related U.S. Application Data
(60) Provisional application No. 60/827,545, filed on Sep. 29, 2006.

(51) Int. Cl. B01J 47/14; C02F 1/469

(52) U.S. Cl. 204/278.5; 204/294; 204/661; 204/666; 205/688; 205/758

(57) ABSTRACT

An electrode for use in a deionization apparatus includes a conductive material that is in a granular form and is arranged in a layer that is defined by a first face and a second face. The electrode includes a substrate that is disposed against the first face, and a first member that is disposed against the second face and is formed to permit a fluid to pass through the first member and into contact with the granular conductive material to permit absorption of ions by the granular conductive material.

### CROSS REFERENCE TO PRIOR APPLICATION

This application claims priority to U.S. Provisional Application No. 60/827,545 filed on Sep. 29, 2006, which is incorporated by reference herein in its entirety.

### TECHNICAL FIELD

The present invention relates generally to an electrochemical separation electrode for removing ions, holding, oxidizing and reducing contaminants and impurities from water, fluids and other aqueous process streams and for placing the removed ions back into a solution during a regeneration operation. The invention further relates to a method of making the same and to a fluid treatment system (e.g., deionization system) using the same.

### BACKGROUND

There are a number of different systems for the separation of ions and impurities from water effluents or the like. For example, conventional processes include but are not limited to distillation, ion exchange, reverse osmosis, electrodialysis, electrodeposition and filtering. Over the years, a number of apparatuses have been proposed for performing deionization and subsequent regeneration of water effluents, etc.

One proposed apparatus for the deionization and purification of water effluents is disclosed in U.S. Pat. No. 6,309,532. The separation apparatus uses a process that can be referred to as capacitive deionization (CDI). In contrast to conventional processes, this technology does not require chemicals during the deionization process but rather, this system uses electricity. A stream of electrolyte to be processed, containing various anions and cations, electric dipoles, and/or charged suspended particles, are passed through a stack of electrochemical capacitive deionization cells during a deionization (purification) cycle. Electrodes in the cells attract Particles or ions of the opposite charge, thereby removed them from solution.

Thus, the system is configured to perform deionization and purification of water influents and effluents. For example, one type of system includes a tank having a plurality of deionization cells that is formed of non-sacrificial electrodes of two different types. One type of electrode is formed from an inert carbon matrix of specific design (ICM). This electrode removes and retains ions from an aqueous solution when an electrical current is applied. The other type of electrode, formed from a conductive material, does not remove or removes fewer ions when an electric current is applied and therefore is classified as being non-absorptive (“non-ICM electrode”). This property is common to electrodes formed from carbon cloth, graphite, titanium, platinum and other conductive materials. The non-ICM carbon electrode is formed as a dual electrode in that it has a pair of conductive surfaces that are electrically isolated from one another.

Accordingly, in one embodiment, the apparatus includes a number of conductive, non-sacrificial electrodes each in the form of a flat plate, that together in opposite charge pairs form a deionization cell. During operation, a voltage potential is established between a pair of adjacent electrodes. This is accomplished by connecting one lead of a voltage source to one of the electrodes and another lead is attached to the electrodes that are adjacent to the one electrode to produce a voltage potential there between.

In order to construct a stable, robust ICM electrode, a reinforcer can be used to strengthen the high surface area absorptive material. Typically, the reinforcer is in the form of a carbon source, such as carbon felt, granular carbon or carbon fiber; however, it can also be in the form of a carbon/cellulose or carbon silica mixture. The carbon source is used as reinforcement in the formation of the electrode and while it can come in different forms, it is important that the carbon reinforcement be electrically conductive and not reduce the electrical conductance of the electrode. A carbon source is selected to permit the electrode to have the necessary conductive properties and must also be fully dispersed in the other materials that form the ICM electrode, namely a resorcinol-formaldehyde liquor, which then sets, or can absorb a similar quantity of the liquor in a matrix and then set.

The non-homogeneity of the prior art electrodes that contain fiber reinforcement affects its absorptive and electrical properties. More specifically, the use of carbon fibers as a carbon reinforcement provides fewer attachment sites for ions and the electrode also tends to be less balanced in the removal of positive and negative ions. Thus, it is desirable to produce a homogenous electrode that is robust and has increased reinforcement characteristics without the use of conventional fiber reinforcement.

### SUMMARY

According to one aspect, the present invention is generally directed to a system or apparatus for the deionization and purification of influents or effluents, such as process water and waste water effluents and more particularly, is directed to a non-sacrificial electrode as well as a method of making the same. The electrodes of the invention do not require carbon-fiber based reinforcement.

According to one exemplary embodiment, the process for making the electrode includes the steps of (1) making a liquor including at least one polymerization monomer dissolved in a first crosslinker (crosslinking agent), (2) maintaining the liquor for a sufficient time and at a sufficient temperature until the liquor polymerizes into a solid, and (3) carbonizing the solid for a sufficient time and at a sufficient temperature such that the solid carbonizes into an electrically conductive substrate.

According to one embodiment, the electrode is formed by (1) dissolving at least one material selected form the group consisting of dihydroxy benzenes, dihydroxy mapthalenes, trihydroxy benzenes and trihydroxy naphthalene's, furfural alcohol, and mixtures thereof, in a crosslinker to form the liquor, (2) maintaining the liquor for a sufficient time and at a sufficient temperature until the liquor polymerizes into a solid (blank), (3) firing the blank at a sufficient temperature and for a sufficient time such that the blank carbonizes into an electrically conductive member and (4) processing the blank, after the blank cools, so as to break up the carbonized blank into the granular conductive carbon material.

One specific exemplary process for forming the present granular conductive carbon material electrode includes the steps of (1) dissolving at lease one material from the group consisting of dihydroxy benzenes, dihydroxy napthalenes, trihydroxybenzenes and trihydroxy napthalenes and mixtures thereof, with a crosslinker (e.g., formaldehyde (37% formalin solution)) to form a liquor (pre-react), (2) mixing the resultant liquor pre-react with a second crosslinker (37% formalin solution) for a sufficient time and at a sufficient temperature until the liquor polymerizes into a first solid (block), (3) firing the first block at a sufficient temperature and for a sufficient time such that the first block carbonizes into an electrically conductive member, and (4) processing the first block, after the first block cools, so as to break up the carbonized first block into a uniform granular conductive carbon material.

Once the granular conductive material is formed, it is disposed into an electrode structure that is generally in the form of a structure that has discrete components or layers. In particular, the granular conductive material is disposed and is held between a substrate (e.g., a conductive plate) and a member that permits fluid to flow into contact with the granular conductive material to allow treatment (deionization) of the fluid. In one embodiment, the member that permits fluid to flow into contact with the granular conductive material is in the form of either a porous material structure or a structure that has openings formed therein, such as a grid-like structure, to permit the fluid to flow into contact with the granular conductive material. The combination of the above structures forms the electrode (cell) that is arranged along with other electrodes in a fluid treatment tank or the like for treatment of a process stream (e.g., deionization of water).

A power source is provided and the alternating substrates of alternating electrodes are connected to opposite polarities of the power source to establish a voltage potential between adjacent electrodes, with the process stream flowing between the adjacent electrodes such that it can flow through the porous or perforated member and into contact with the granular conductive material.

A system and process for regenerating the granular conductive material are also provided in which, and in contrast to conventional techniques, the viscous, free flowing positively charged granular conductive material associated with one electrode is removed from the electrode structure and then mixed with the viscous, free flowing negatively charged granular conductive material that is associated with the other electrode. After removal of the attached ions, as described herein, the regenerated granular conductive material is then delivered back to the respective electrode structure by means of a regeneration loop.

Other features and advantages of the present invention will be apparent from the following detailed description when read in conjunction with the following drawings.

### BRIEF DESCRIPTION OF THE DRAWING FIGURES

The foregoing and other features of the present invention will be more readily apparent from the following detailed description and drawings of illustrative embodiments of the invention in which:

FIG. 1 is a schematic diagram of a fluid treatment system, such as a deionization system, that includes a fluid treatment loop and a regeneration loop;

FIG. 2 is a cross-sectional view of a fluid treatment tank with a plurality of electrodes arranged therein;

FIG. 3 is a side perspective view of one electrode for use in the fluid treatment tank; and

FIG. 4 is a side elevation view of a pair of electrodes with a fluid channel being defined between the electrodes.

### DETAILED DESCRIPTION

As noted above, the present invention is directed to an electrode and fluid (water) deionization systems employing this electrode. The electrode of the invention has superior absorption characteristics compared to prior electrodes for water deionization. Perhaps as importantly, the manufacturing process is simple and in certain embodiments employs readily available starting materials. Thus, the invention greatly facilitates development of cost-effective water deionization devices for industrial, commercial, and residential decontamination uses.

It will be appreciated that while the present invention is described herein as being a water deionization system and an electrode for use therein, the present invention is not limited to this particular type of application and can be used for treatment of fluids other than water based solutions.

Non-Sacrificial Electrode

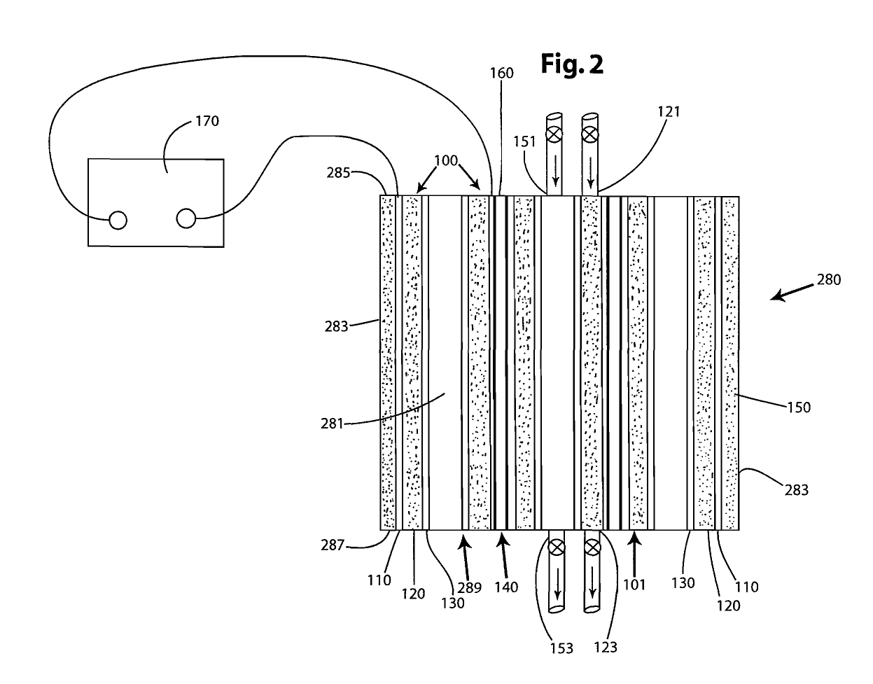

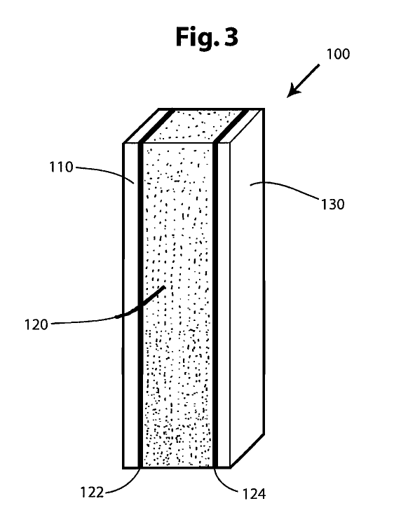

The present invention generally refers to an electrochemical separation electrode 100 (FIGS. 2-3) for removing charged particles, ions, contaminants and impurities from water, fluids and other aqueous or polar liquid process streams and its suitable applications. For example and according to one exemplary embodiment, the present electrode 100 is particularly suited for use in a deionization system that includes a number of parallel arranged, upstanding electrodes 100. As discussed below, the system can include a single type of electrode or the apparatus can be formed of more than one type of electrode arranged in an alternating pattern within the system. For example and according to one deionization scheme, a single type electrode is used and arranged so that adjacent electrodes are oppositely charged for attracting particles of opposite charge. It will be understood and appreciated that the illustrated system merely illustrates one use of the present electrode and there are a great number of other uses for the electrode, including other deionization applications as well as other types of applications.

The electrode 100 can be used in a flow-through, flow by, or batch system configuration so that the fluid can utilize a charged surface area for attracting oppositely charged ions, particle, etc. It is also possible for a frame to be disposed around the electrode 20 to provide structural support around the perimeter of the electrode 100.

The system can be constructed in a number of different manners and the electrodes can be arranged in any number of different patterns within the apparatus. For example, U.S. Pat. Nos. 5,925,230; 5,977,015; 6,045,685; 6,090,259; and 6,096,179, which are hereby incorporated by reference in their entirety, disclose suitable arrangements for the electrodes contained therein. As stated above, in one embodiment, the system includes a number of conductive, non-sacrificial electrodes that each is in the form of a structure of arranged members that together forms a deionization cell. During operation, a voltage potential is established between a set of adjacent electrodes. This is accomplished by connecting one lead of a voltage source to one of the electrodes and another lead is attached to the electrodes that are adjacent to the one electrode so as to produce a voltage potential there between. This can result in adjacent electrodes being charged oppositely. However, it is to be understood that the above-mentioned electrode embodiment is merely exemplary in nature and not limiting of the present invention since the present invention can be manufactured to have a number of designs besides an electrode formed of distinct members or materials that are arranged relative to one another.

According to one aspect of the invention, a polymerized pre-form is first made, then carbonized and processed to form the conductive carbon material used in the final electrode. The present electrode is formed so that it does not require the use of a fiber reinforcer, which is typically in the form of a carbon source, such as carbon felt, paper, or fiber or a carbon/cellulose mixture.

The polymerized pre-form that is used for preparing the conductive carbon material is generally formed from a polymer liquor, which is formed of a number of ingredients including the polymerization monomer, the crosslinker, an optional catalyst or activator, and inert ingredients, such as water, alcohol, etc., as described below in greater detail.

Polymer Liquor

Accordingly, the polymer liquor refers to a mixture that includes a polymerization monomer as well as a crosslinker that is capable of dissolving the polymerization monomer as to suspend the polymerization monomer in solution. The polymer liquor can also contain inert ingredients, such as water, alcohols, etc. It can accommodate addition of a polymerization catalyst or activator that induces or accelerates the polymerization process.

Polymerization Monomer

The polymerization monomer should be (i) capable of crosslinking with other monomers to form a polymer which in turn (ii) can be carbonized to form an electrically conductive material. In one embodiment, preferred polymerizing agents are in the form of poly-hydroxy aryl groups, especially, di and tri hydroxyl benzene and naphthalene. A specific dihydroxy benzene for use in the invention is resorcinol. In a specific embodiment, the monomer is selected from the group consisting of phenol, furfural alcohol, dihydroxy benzenes, dihydroxy napthalenes, trihydroxy benzenes and trihydroxy napthalenes and mixtures thereof.

Resorcinol comes in many different grades and can be obtained from a number of suppliers in pellets, flakes, and other convenient forms. For example, resorcinol in a form suitable for organic chemical formulations, commercially available from the Hoechst Celanese Company, can be used to make the present electrode.

As mentioned, one preferred material is resorcinol catalyzed with a base. The resultant polymer must be capable of being carbonized and result in a highly-conductive material. Thus, if the material is to hold a shape, it must form a char as opposed to forming a liquid phase during any part of the carbonization. As a result, it is believed that the ring structure available in certain natural materials, such as coconut shells, possesses the basic structures in their cellulose structures, which can form a conductive carbon, which may be used.

Crosslinker

The solvent of the polymer liquor is typically in the form of a bi-reactive molecule or cross-linking agent that can dissolve the polymerizing agent to form the polymer liquor. One particularly preferred solvent is formalin. However, other crosslinkers can be used including gluteraldehyde or a solid source of formaldehyde, such as paraformaldehyde and Methenamine and hexamethylene tetraamine. Formaldehyde is available from a variety of suppliers, and also comes in different grades and forms. For example and according to one embodiment, the formaldehyde can be in the form of formalin, which is suitable for dyes, resins and biological preservation, from the Georgia-Pacific Resin, Spectrum Chemical Company.

Catalyst

The catalyst regulates the polymerization rate and endows certain physical characteristics to the polymer that are evident in the carbonized structure. By varying the type of catalyst, the porosity and strength of the final product can be altered. Any number of catalysts can be used so long as they serve to initiate or accelerate crosslinking. For example, for resorcinol-formaldehyde type polymers, a caustic or base catalyst can be used and in particular, sodium carbonate, sodium hydroxide or potassium hydroxide or other base catalysts are suitable for use in the present invention. When methylol compounds are used, a base catalyst can initiate such a reaction. Also, it is desirable to use a catalyst that will introduce the least amount of contamination into the mixture.

Pre-Prepared Liquors

While preferred starting ingredients for the blank for forming the granular material include mixed resorcinol/formaldehyde liquor, there are alternatives to mixing these reactants. Commercially available products and reacted mixtures of resorcinol and formaldehyde are available under the generic categories of resoles and novolaks. Each of these products is a mixture of resorcinol and formaldehyde and catalyst that is not reacted in molar ratios that will result in a solid. These alternatives permit a custom manufactured mixture to be provided that can be tailored to the desired molar and viscosity ratios of catalyst, formaldehyde, and resorcinol.

Granular Conductive Carbon Material

As described below in more detail and as used herein, the terms “granular conductive carbon material” and “granular conductive material” refer to a particulate matter that can be ground carbonized blank material or it can be another carbon-based particulate conductive material. Preferred granular conductive carbon materials are those materials that will neither sacrifice in an electrical field nor dissolve in water and poses the ability to remove ions from solution when electrically charged.

While in one embodiment, the granular conductive carbon material is formed by first creating the carbonized absorptive material and then processing it so that it is broken into smaller particles, it will be understood that in another embodiment, a granular conductive carbon material possessing the specific characteristics necessary to deionize water could be commercially purchased and then used. As a result, certain activated carbons and even glassy carbon structures could produce satisfactory results in certain applications. It will also be appreciated that other materials which form electrically conductive chars such as coconut shells or coal based activated carbons which can be carbonized and broken down into a powder or granular form can be used in some applications as the granular conductive material.

Process for Forming the Electrode

The goal of making the electrode according to one embodiment is to produce a granular electrically conductive, homogenous, porous carbon structure that functions as part of an absorptive electrode structure that is utilized in a deionization system that is constructed to remove ions from a liquid when an electric current is applied.

The manufacturing process for forming the electrode generally includes the steps of polymerizing a liquor (blank material), carbonizing that polymerized blank material into a granular conductive carbon material, and incorporating the granular conductive carbon material into an electrode assembly.

Polymerizing the Blank

According to one exemplary manufacturing process, the polymerization monomer and crosslinker are measured out in appropriate amounts to form the polymer liquor that is used to form a pre-blank partial reaction and mixed. After the first polymerization reaction has finished the pre-blank polymer is mixed with additional crosslinker to form a blank with the desired physical characteristics. All mixtures are stirred until homogenous. A polymer initiator (catalyst) can be added to speed up the reaction however, it is possible for the polymerization process to proceed without the use of an initiator and in this case, polymerization occurs as a result of the passage of time. The polymer liquor is dispensed into a mold (e.g., an open top forming mold) that is preferably kept at a controlled temperature. The temperature of the mold can be maintained at a desired temperature using any number of conventional techniques, including the use of a heating element or the use of a bath or the like which is capable of maintaining the mold at the desired temperature. After letting the formed solid sit for a sufficient time period, the hardened solid is removed from the mold and carbonized.

The process of forming the blank material thus begins with forming a polymer liquor with an approximately 0.4-0.6 to 1.0 molar ratio of the crosslinker to polymerization monomer. For example, a batch of 7500 grams of resorcinol solid is added to 2765 grams of formalin solution (37% formaldehyde with 11% methanol). After the first reaction has finished and cooled a final crosslinker volume is added to the mixture resulting in a final molar ratio of approximately 1.2-1.8 to 1 crosslinker to polymerization monomer. For example, an additional 4975 grams of formalin solution (37% formaldehyde with 11% methanol) is added to the mixture in this specific example.

It will be understood that the above listed quantities are merely exemplary in nature and that these quantities can be scaled linearly, either upwards or downwards, to make different total quantities of the initial mixture that is used to form the blank.

The rate at which the polymerization monomer dissolves in the crosslinker depends on a number of factors, including the molar ratio between the two materials. Mixing or stirring the combination can aid the process and conversely, raising the temperature can result in the process being sped up. As is commonly known, when it comes to dissolving one material in another material, time can be traded for temperature and therefore, there are a number of different ranges of temperatures and times that can be used to dissolve the polymerization monomer in the crosslinker.

The polymer liquor is then permitted to polymerize by placing the polymer liquor in suitable conditions that allow the polymerization process to proceed. A catalyst can also be used to facilitate polymerization of the polymer. The polymerization time and catalyst and the temperature are controlled, with the temperature preferably being held between about 70° F. and 125° F. In view of the foregoing, the optimal way to make the blank is to control the temperature during polymerization to produce a solid uniform structure.

The Mold

The mold that is used to form the blank can have a number of different configurations and can be formed of a number of different materials. For example, the forming mold can be a stainless steel forming pan, such a 300 series stainless, that is square shaped. However, it will be appreciated that the mold can be formed of other materials, such as aluminum and plastics that specifically don't have any bonding characteristics with the polymer liquid. One type of plastic that is suitable for making the mold is polyethylene; however, other plastics can be used to form the mold.

The mold is preferably prepared to receive the polymer liquor. More specifically, if the mold has a texture that will stick to the work piece, then a mold release agent is used to facilitate the removal of the solid that is subsequently formed in the mold. One exemplary mold release agent is carnauba wax that is spread on the surfaces of the mold prior to addition of the polymer liquor. It will be appreciated that there are other mold release agents that can be used with the mold. If a mold release agent is not used, then a liner can be directly incorporated into the metal mold. For example a polyethylene liner can be directly incorporated into a steel mold and this eliminates the need for the use of an applied release agent. However, it will be understood that the mold liner can also be made out of other materials, such a craft paper or any other material that will not bind with the polymer.

While the mold can be any shape or geometry that the polymer liquor can be poured, it also can be an injection mold. As is known, an injection mold includes two complementary portions that mate to form an enclosure. One or both of the complementary portions is provided with an inlet through which the polymer liquid is introduced and the injection mold is further provided with a vent. Injection can take place at a wide range of pressures, depending on the type of injection molding techniques used, the viscosity of the injectant, and other factors. In the alternative embodiment the mold is a container with a lid. However, it will be appreciated that the mold alternatively can be a sealed cavity that is then regulated in terms of its temperature. For example, the mold can be immersed into a temperature-controlled bath that serves to control the temperature of the mold itself. However, the mold can have a solid state of flow-through temperature regulator that serves to control the temperature of the mold.

Curing the Blank

In one embodiment, the mold containing the polymer liquor mixture is introduced to convection type heating between about 70° F. to 145° F. for a time period of about 24 to 72 hours. Other heating sources may be used. During this curing stage, the in-mold cured blocks are hard, and damp with some unreacted formaldehyde and are electrically non-conductive. One purpose of this in-mold heating is to accelerate the hardening and shrinkage so that the block can be removed from the mold.

The polymerized liquor is at this time amber, glassy appearing polymerized solid that is typically referred to as a xerogel. After the polymer liquor has set and turned to a solid and is removed or released from the mold.

Carbonization of the Blank

After the non-conductive blank has been cured and it is removed form the mold it is placed in an oven so as to fire and carbonize it into the granular conductive carbon material. Preferably, the carbonization process is undertaken in an oven that is heated by any number of means, including but not limited to being heated by electricity, natural gas, or infrared energy, etc.

In one embodiment illustrated, the heating device is an infrared (IR) heater. The present applicants have discovered that the use of an infrared heater yields a number of desirable advantages, including a significant time savings in the preparation process. More specifically, carbonization process takes generally from 1 to 4 hours in a conventional furnace, while the carbonization process has been cut down to between 10 minutes and 30 minutes when using an IR furnace. This results in not only a significant timesavings but also a cost savings since the production time and energy use is significantly reduced. In addition, the use of an infrared oven offers a number of other benefits/advantages, including the ability to have instant real-time control of the temperature. More particularly, conventional ovens have slow response times in that when a temperature change is needed and the oven is instructed to change temperature, there is typically a significant lag time before such new temperature is realized. In contrast, the use of the present infrared furnace for carbonizing the present electrode material permits instant real-time control of the temperature within the oven and since the temperature can quickly be changed, and held at a specific temperature, the characteristics of the material can be controlled. By being able to precisely control the temperature heating profile of the oven in real-time, the electrical performance properties, e.g., conductivity, etc., of the electrode can be altered and tailored to a specific application.

Advantageously, the construction of the oven can lead to an improved manner of introducing heat to the blank that is placed in the oven for the purpose of carbonization thereof. In one embodiment, the oven includes two heated components that can be in the form of two infrared heater panels. In another embodiment, the oven includes a first refractory and a second refractory and according to one embodiment, the first refractory is a hearth refractory and the second refractory is a movable refractory. The movable refractory is disposed within the oven such that it represents the upper refractory of the two refractories; however, it will be appreciated that the lower refractory can be configured so that it is the movable refractory as opposed to the upper refractory. The refractory has a dual purpose but when it is used in the carbonization process with the blanks, the purpose of the refractory is to get the correct degree minutes per gram of heating so that the blank material is thoroughly raised to a predetermined temperature. For example, the blank material is heated to a temperature between about 700° C. to 1000° C.

Another parameter to observe is the atmosphere of the oven. In the present process, the atmosphere of the oven is not controlled with inert gas but rather, the atmosphere is controlled by the design of the oven. More specifically, the design of the oven is such that it prevents oxygen from being in contact with a major portion of the surface of the material of the blank due to the presence and construction of the upper and lower refractories. However, it will be appreciated that the atmosphere of the oven can be controlled using both inert gas and by design of the oven. In other words, an inert gas, such as nitrogen, can be used to control the atmosphere of the oven as opposed to using exhausted gases to accomplish this feature.

According to one embodiment, the material is in an oxygen-starved environment because the refractories prevent oxygen form penetrating. The oven is purged of atmosphere through the combustion gasses created in the initial first minutes of carbonization. After these initial minutes, there is no air brought into the oven and therefore, the material is in a reduced oxygen environment.

It will be appreciated that the purpose of firing the blank material is to convert it from a phenolic polymer or plastic into a carbon material. In other words, the firing process is a carbonization process. A suitable temperature range for the oven is between about 700° C. to about 1000° C. Temperatures that are not suitable are those temperatures at which the physical characteristics of the blank material become undesirable with respect to several aspects, including but not limited to, electrical conductivity; volume conductivity; and strength. The bulk resistivity of the carbonized material is high when the temperature is below 700° C. and if the temperature of the oven is too high the material will become too graphitic.

Subjecting the blank material to the above temperatures causes further desiccation and burns off many of the impurities present in the original ingredients. The blanks are then heated for a predetermined time period to complete the carbonization process and it has been determined that the time of heating and the temperature of heating together depend on the weight of the unheated blank. The heating protocol is significantly influenced by the thickness of the material.

A thermocouple can be used on the top of the material and is used to compare the material temperature to the oven temperature, with the temperature of the material lagging the oven temperature. Bulk resistivity is one of the primary checks to see if it has been converted into a usable carbon form. The carbonization of the blank material involves taking the plastic material and converting it to carbon.

After the blank material is completely fired and carbonized, the oven is opened and the carbonized blank material has an orange glow due to the temperature of the material. The blank material will be fractured and in pieces as a result of the carbonization process. The blanks can be fired in a container, such as a stainless steel pan, to prevent the loss of material. The pan retains the broken and fractured material so that recovery from the oven is complete. While the stainless steel may be suitable in some applications, stainless steel does not have to be the selected material of the container; however, the selected material should be able to withstand the high temperature and not add contamination to the blank conductive carbon material.

The container is removed mechanically with a tong or a pusher or some other type of tool that permits the container to be securely gripped and then removed form the hot oven. As the pan is removed form the oven, there is a slight hint of flame coming off of the blank material as it is exposed to oxygen. In order to prevent burning of the material after the container is removed from the oven, a refractory snuffing block can be provided and laid on the container to prevent oxygen form getting to the blank. It is also possible to create an environment where the material can cool quickly including water quenching. Once the temperature of the blank reaches a predetermined temperature, such as 200° C., the carbonized blank can be removed from an oxygen reduced environment created by the snuffing block.

Formation of Granular Conductive Material

Once the blank is cooled to room temperature, the blank is then further processed. More specifically, the room-temperature blank is introduced to a process that is configured to break up the blank into smaller pieces. In one exemplary embodiment, the blank is run through a crushing hammer mill process that is constructed to break up the blank into particles that are of a known size and distribution. Any number of different methods can be used to break up the material into smaller particles. One preferred method for breaking up the blanks is to run the carbonized blank material through a jet mill. The jet mill requires a pre-crushing stage due to the fact that the jet mill cannot handle feed particles larger than ⅛ inch diameter. This pre-stage can be any means that will provide appropriately sized feed material for the jet mill. This material is extremely hard and abrasive so a tungsten carbide or equally hard material should be considered as the crushing material when using hammer mills or similar equipment.

Thus, it will be appreciated that any number of conventional milling processes and techniques can be used to form the granular conductive carbon material. The techniques disclosed herein are merely exemplary and not limiting of the present invention in any way.

According to one embodiment, the first step is to use the crusher to crush the big chunks and for example, the crusher reduces the big chunks of the blanks to a predetermined smaller size, e.g., about ⅛ inch in size prior to the subsequent step of using the jet mill device. This first device is therefore a preliminary tool or device (lump breaker or a crusher) that is used prior to the jet mill step. The ⅛ inch material is then taken form the lump breaker or crusher into the jet mill.

The hammer mill device is configured with the correct hammers, clearances and RPMs (all of which are variables) to produce the particle distribution size that is desired. Yet another function that can be controlled is the feed rate of the broken-up blank material into the hammer mill. It will be appreciated that there are other devices that can be used to grind or reduce the blank material to a smaller particle size. Thus, the use of the hammer mill is not critical to the present process and instead, a pin mill, a ball mill, a roller mill, etc., can be used.

After the broken-up blank material passes through the mill, the resulting particles of blank material size have a size that falls substantially within the range from about 1 micron to about 500 microns, preferably between 40 microns and 150 microns, and in one embodiment between 40 microns and 120 microns. However, these ranges are merely exemplary ranges and it will be appreciated that depending upon the application and upon the desired dimensions of the resulting crushed particles, the equipment (e.g., the crusher and the hammer mill) can be selected and arranged so as to produce particles of given, desired dimensions.

The purpose of forming a blank including the curing and then the carbonization thereof is to form a conductive carbon material and then the grinding thereof is to convert the large carbonized material into smaller micron sized conductive particles. This material can also be referred to as being a granular carbon material.

The granular carbon material is typically a very porous, hydrophilic dry material.

Incorporating the Granular Electrode Material into an Electrode Structure

As previously mentioned, the electrode 100 according to one exemplary embodiment of the present invention is in the form of an assembly of a plurality of members. More specifically, the electrode 100 is formed of three members or materials or layers that are disposed in relation to one another, namely, a substrate 110, a member 120 that is formed of granular conductive material, and a barrier member 130, with the granular conductive material 120 being disposed between the substrate 110 and the barrier member 130. The electrode assembly 100 can take any number of different shapes and sizes and according to one embodiment; the electrode assembly 100 has a square or rectangular shape. However, these shapes are merely exemplary and illustrative in nature and any number of other regular and irregular shapes can be used. The electrode assembly 100 has a shape and dimensions that are complementary to the shape and dimensions, respectively, of a fluid treatment tank where the fluid (e.g., waste water) is introduced for treatment (e.g., deionization) thereof.

It will be appreciated that while the thicknesses of the members 110, 120 and 130 can be the same, the members typically have different thicknesses.

The electrode 100 is generally disposed in an upright manner within the interior of the fluid treatment tank such a bottom edge 101 of the electrode 100 seats against a floor of the tank according to one embodiment. The members 110, 130 can be fixedly mounted in the interior of the tank such that the two are mounted in an upright manner with a predetermined distance defined therebetween so as to provide the space that receives the granular conductive material. In this embodiment, the sides of the electrode 100 face and are opposite respective sides of the fluid treatment tank. The electrodes 100 can be arranged in a number of different ways to define a number of different flow paths for the fluid that is introduced into the tank for treatment thereof by means of the electrodes 100. In the illustrated embodiment, a plurality of electrodes 100 are arranged side-by-side along the length of the fluid treatment tank, with the barrier members 130 of one set of adjacent electrodes facing one another, while the substrates 110 of some of the electrodes 100 face substrates 110 of other electrodes 100. In other words, the electrodes 100 are arranged in pairs that are arranged back-to-back in that the substrates 110 of one pair face another with a first space 140 (vertical space or vertical channel) formed therebetween for receiving a device 160 that compresses the electrode 100 as described below. The barrier members 130 of this pair face barrier layers 130 associated with two different pairs of electrodes 100 such that between opposing barrier members 130 of two electrodes 100, a second space 150 (vertical space or vertical channel) is formed to permit the fluid that is being treated and introduced into the fluid treatment tank to flow as described below. The width of the first space 140 can be different from the width of the second space 150; however, the precise relationship between these dimensions can be varied from application to application.

The substrate 110 serves as a backbone to the layered electrode structure 100 and can be formed of any number of different non sacrificial conductive materials. For example, the substrate 110 can be formed of graphite; any steel composition that is non-sacrificial and electrically conductive; conductive polymers, epoxies, plastics or rubber; and any non-ferrous materials that are non-sacrificial and electrically conductive, such as gold, silver, platinum, titanium, aluminum, etc.

Depending upon the type of treatment and other parameters, such as the relative dimensions of the treatment tank and the quantity of fluid that passes through the tank per unit of time, etc., the physical and electrical properties of the substrate 110 will vary. For example, the substrate 110 can have an area from about 0.001 square inch to in to greater than 10,000 square inches, the width of the substrate 110 can be from about 0.001 inch to greater than 1 inch and the bulk resistance of the conductive material that forms the substrate 110 can be between about 0.1 milliohm to about 10 ohms.

In the illustrated embodiment, the substrate 110 has a plate-like form that can come in any number of different shapes, such as a square or rectangle, and different sizes.

Preferably and according to one embodiment, each of the electrodes 100 has the same dimensions, as well as the same physical and electrical properties so as to provide a uniform electrode arrangement.

The granular conductive material 120 is preferably formed in the manner described above and is in the form of pulverized or otherwise broken apart pieces of the carbonized blank described earlier. The particle size of the granular conductive material 120 is preferably between about 1 to about 500 microns in one embodiment, with one exemplary range being from about 40 microns to about 120 microns. For example, the granular conductive material 120 can have an average particle size of greater than 50 microns but less than 100 microns or it can be between about 100 microns and about 120 microns. The granular conductive material 120 can thus be thought of as free flowing powder-like substance that has different properties, depending upon the precise particle size thereof, and the operating conditions.

Since the member 120 is in the form of granular conductive material, this material has a high degree of flow and can easily flow along a path when a force is applied thereto or under gravitational forces. In other words, the granular conductive material is highly fluidic in nature and this permits the electrode material (granular conductive material) to be easily flushed from the fluid treatment tank. More specifically, a slurry formed of a fluid, such as water, and the granular conductive material 120, can have a number of different viscosities that are conducive to easily flowing within a regeneration loop to permit regeneration of the granular conductive material 120 in a regeneration tank and permit delivery of the regenerated electrode material back into member 120 of the electrode 100 that is contained in the fluid treatment tank. Details of the regeneration system and process are found below.

The granular conductive material 120 has an associated pore size that can be in a range from about 10 to about 100 μmÅ and can have a surface area between about 400 to about 1200 m²/g (BET).

The barrier member 130 can take any number of different forms including a structure that is formed of a porous material that permits the fluid (e.g., water) flowing within the second space 150 to flow through and into contact with the granular conductive material of member 120. The barrier member 130 can also be formed of a non-porous material (e.g., polyethylene (PE)) that is formed as a sheet that includes a number of through openings so as to form a grid like pattern, with the fluid flowing through these openings and into contact with the granular conductive material of member 120.

When the barrier member 130 takes the form of a porous member, the barrier member 130 can be formed of any number of different materials so long as they have a sufficient degree of porosity to permit fluid that flows within the second space 150 to flow therethrough and into contact with the granular conductive material that makes up the member 120. The porosity of the member 130 can vary from application to application; however, according to one embodiment, the porosity of the member 130 is between about 1 μm and about 5000 μm. As with the other members, the barrier member 130 can be provided in different widths, such as, for example, between about 0.001 inch and 2.00 inches.

It will be appreciated that since the barrier member 130 is disposed against one face of the granular conductive material member 120, it acts as a barrier to prevent the granular material from moving into the second space 150. Thus, the particle size of the granular conductive material and the pore size of the barrier member 130 are selected such that the pore size of the barrier member 130 prevents the granular conductive material from being able to travel through the pores (openings) formed through the barrier member 130.

The porous barrier member 130 can be formed of any number of different types of porous materials, which are preferably, but not necessarily, non-conductive in nature or the barrier member 130 can be formed of non-conductive materials that can be formed as a grid like structure. For example, the barrier member 130 can be formed of a material selected from the group consisting of a porous plastic (e.g., PE, Derlin, UHMW, HDPE, Nylon, Polycarbonate, etc.); a mesh formed of polyester, nylon, etc.; a non-conductive carbon foam; a non-conductive ceramic foam, etc. The barrier member 130 has a geometry that complements the structure 120 formed of granular conductive material.

It will also be understood that the barrier member 130 can be in form of a plastic or synthetic cloth-like structure and can have any number of different constructions, such as a honeycomb structure.

In its operative state, the granular conductive material 120 is in a compressed form or state in that the device 160 is provided for applying a predetermined compressive force to the granular conductive material 120 so as to cause the loose, free granular conductive material to assume a more compact, defined layer or structure. When compressed, the thickness of the member of the granular conductive material is reduced and in one exemplary embodiment, the member 120 of granular conductive material has a thickness between about 0.010 inch and about 1 inch; however, these values are merely exemplary and depending upon the particular application, the member 120 can have a thickness outside of this range.

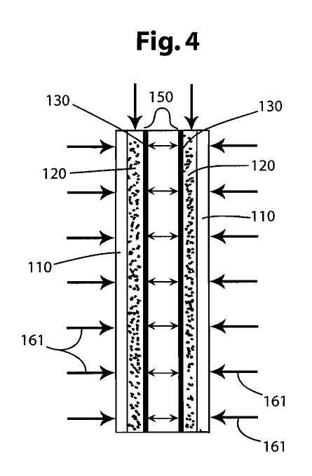

The granular conductive material can be compressed by applying pressure either in a horizontal direction or by applying pressure in a vertical direction against and with respect to the granular conductive material. In FIG. 4, arrows 161 show compression being applied in a horizontal direction.

The device 160 can take any number of different forms so long as it is configured to apply a positive pressure (compressive force) to the member 120 of the granular conductive material and preferably, the device 160 is constructed to apply positive pressure along the length (height) of the member 120. For example, the device 160 can be in the form of a compression bladder 160 that is disposed in the first space 140 and extends along the entire length or a substantial length of the member 120 such that when the compression bladder 160 is actuated and inflated, a positive force (compressive force) is applied to the granular conductive material 120. The compression bladder can be operatively connected to a source of positive pressure, such as an air compressor, that is fluidly connected to the bladder structure, as well as being operatively connected to a control system, such as the master control system or processor, that permits the bladder structures to be controlled and selectively inflated at desired times as when performing deionization within the interior of the tank. It will be appreciated that the inflation of the bladder causes a compression of the granular conductive material along its length as shown by arrows 161 in FIG. 4.

When regeneration is desired and as will be described below, the pressure within the bladder 160 is released (deflated) to permit the release of the granular conductive material from the member 120. The granular conductive material can then be discharged from tank and delivered into a regeneration loop for regeneration thereof.

It will be understood that other types of devices 160 can be used to compress and hold the granular conductive material in place in member 120. For example, mechanical pressure can be generated by a mechanical device resulting in compression of the granular conductive material. One type of device is a mechanical plunger that can be actuated to apply positive pressure (compression) to the granular conductive material in a vertical direction. In this design, the plunger can contact a top section of the member 120 and apply a downward force to compress the member of granular conductive material. The device 160 can also be in the form of a floating O-ring that can be placed under pressure.

In addition, it will be understood that the device 160 can be in the form of a mechanical, electrical, hydraulic or pneumatic bladder or some other type of mechanical, hydraulic or pneumatic component. The bladder can consist of a conductive material or a non-conductive material. The device 160 can thus be in the form of any volume reduction mechanism that would consist of mechanical, electrical, pneumatic or hydraulic means.

According to one embodiment, the device 160 applies a force that has an associated pressure between ambient conditions and about 1000 psi; however, this range is merely an exemplary range and it will be appreciated that pressures exceeding 1000 psi can be used under some conditions and applications. The operation of the device 160 can result in volume decreases on the order of from about 0.1% to greater than 50%.

Moreover, it will be appreciated that the compression of the granular conductive material can occur from any or all sides of the material (member 120).

It will be understood and as illustrated in FIG. 2, the first space 140 formed between two opposing substrates 110 is for receiving the compression device 160 so that when actuated, the device 160 expands and applies a pressure to the opposing substrates 110. Preferably, the force is applied in a direction that is substantially perpendicular to the exposed faces of the substrates 110. Since fluid, such as water, is contained in the second spaces 150 along with a rigid structure constructed of either porous plastic or a hollowed out plastic structure, a force is applied by the fluid and structure against the exposed faces of the barrier members 130, thereby causing the granular conductive material to be effectively sandwiched between the other two members 110, 130. In other words, the water and rigid structure offers a high degree of resistance to movement of the electrode 100 in a direction of the force applied by the device 160 and this permits the granular conductive material to be contained in a well defined member 120 as part of the electrode 100 despite the granular conductive material having a relatively high degree of velocity. The substrates 110 of the electrodes 100 that are located adjacent the end walls of the fluid treatment tank are supported directly by the end walls and there is no need of a compression device 160 adjacent to these surfaces.

Fluid Treatment System Incorporating the Present Electrodes

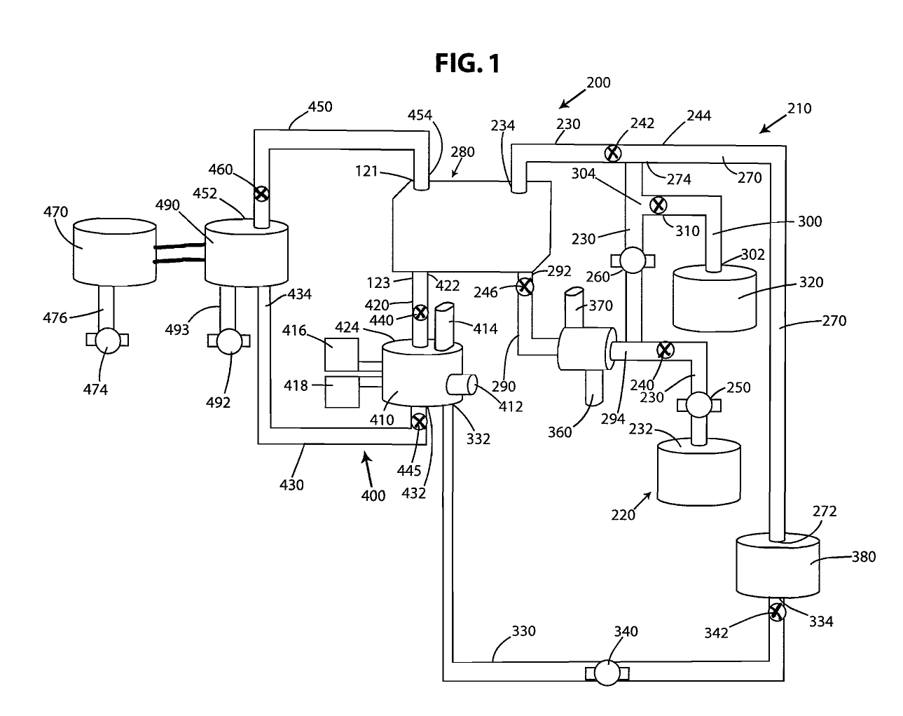

Now referring to FIGS. 1-2, a system 200 for deionization of a fluid is illustrated and generally includes a fluid treatment circuit or loop 210 for treating a fluid, such as waste water, so as to deionize and otherwise treat the fluid to produce treated water that can be discharged to some other location. The fluid treatment circuit 210 includes a source of fluid 220 that is to be treated and in one embodiment, the fluid 220 is process water that contains unwanted matter, such as different ions, metals, etc. The source of fluid 220 can be in the form of a storage container, receptacle or tank that stores a predetermined volume of fluid and can be operatively coupled to an inlet line that delivers process fluid to the tank. In this manner, once a first batch of fluid is delivered to and through the fluid treatment circuit 210, a next batch of fluid is then delivered for storage in the receptacle. For example, the inlet line can be in the form of a fluid conduit (e.g., tube) that delivers the fluid, in a controlled manner, to a location where the fluid is treated. It will be appreciated that the size (volume) of the receptacle that holds the fluid will vary depending upon the precise application and depending upon how much fluid is to be treated.

It will be understood that as used herein the term “conduit” can refer to a separate and distinct member that carries fluid from one location to another or it can refer to a demarcated segment or section of a single continuous conduit. In other words, while the below discussion describes a number of different conduits, one or more of the conduits may define a single continuous flow path.

The fluid treatment circuit 210 also includes a first conduit 230 that includes a first end 232 that is fluidly attached to the fluid source 220 and an opposite second end 234 that is fluidly connected to a fluid treatment receptacle (tank) 280 where the fluid from source 220 is treated by means of operation of the electrodes 100, as described herein, that are arranged in the receptacle 280. The first conduit 230 can be in any number of different forms but typically is in the form of tubing, such as PVC tubing, that is designed to carry the type of fluid that is being treated without any damage or weakening of the tubing itself. As illustrated, the first conduit 230 can be defined by a number of different tube sections that are formed at angles relative to other tube sections or the first conduit 230 can be for the most part a linear conduit that extends between the receptacle 280 and the source 220.

The first conduit 230 has a number of valve members that are associated therewith for controlling the flow direction (fluid pathway or route) and/or the flow rate of the fluid as it flows from the fluid source 220 to the receptacle 280. For example, the first conduit 230 can include a first valve member 240 that is located along the first conduit 230 closer to the first end 232 thereof and a second valve member 242 that is located within the first conduit 230 further downstream from the first valve member 240 and closer to the second end 234 that is fluidly attached to the receptacle 280.

As will be appreciated below, the first and second valve members 240, 242 can be any number of valve members that are operable to permit or restrict flow of fluid within one or more sections of the first conduit 230 so as to either isolate the first conduit 230 from other conduits or permit fluid communication between the first conduit 230 and other conduits or other system components, such as the fluid treatment receptacle 280. The valve members 240, 242, as well as other operative components of the system, are preferably in communication with a controller (processor) or the like, which permits the individual valve members 240, 242 to be selectively controlled and placed into a desired position, such as a fully opened position or a closed position.

The system 200 also has a number of pumps or the like that are associated therewith for selectively and controllably routing fluid along a desired flow path. For example, the first conduit 230 can include a first pump 250 and a second pump 260 that are operably connected and in communication with a controller, such as a master controller or processor, that permits each pump to be independently controlled. The first pump 250 is preferably disposed closer to the first end 232 near the source of process fluid 220 and preferably upstream of the first valve 240. The first pump 250 thus acts as a primary means for withdrawing the fluid from the source 220 and then directing it along the first conduit 230 to another location or another conduit.

The second pump 260 is disposed downstream of both the first pump mechanism 250 and the first valve 240. The second pump 260 can be operated to further direct the fluid along the first conduit 230 or recirculate fluid in and out of the treatment box 280 for quality testing at the pH and conductivity sensors.

The system 200 also includes a second conduit 270 that has a first end 272 that is in fluid communication with a treated fluid receptacle 380 that is intended to store the fluid that has been treated in and discharged from the fluid treatment receptacle 280. An opposite second end 274 of the second conduit 270 is in fluid communication with the first conduit 230 and in particular, a third valve member 244 is provided where the second conduit 270 joins the first conduit 230. Thus, the third valve member 244 serves to selectively open and close the second conduit 270 with respect to the first conduit 230. The second valve member 242 and third valve member 244 can be disposed on opposite legs of a T-shaped fluid intersection between the first and second conduits 230, 270 such that when the third valve member 244 is closed and the second valve member 242 is open, the fluid from the process fluid receptacle 220 can flow through the first conduit 230 and into the fluid treatment receptacle 280. This is the case when the process fluid (e.g., process water) is to be initially delivered to the fluid treatment receptacle 280 for treatment (e.g., deionization) thereof.

The system 200 also includes a third conduit 290 for recycling water being treated in box 280 past sensors to determine treatment condition that has a first end 292 that is fluid connected to an outlet port of the fluid treatment receptacle 280 for receiving fluid therefrom and an opposite second end 294 that is in fluid communication with the first conduit 230 at a location that is downstream of the first valve 240 to permit fluid from the fluid treatment receptacle 280 to be selectively routed from the third conduit 290 to the first conduit 230 past quality sensors 370 through pump 260 back into treatment box 280. Since the third conduit 290 is in fluid communication with the first conduit 230 at a location downstream of the first valve 240, closure of the first valve 240 permits the fluid from the fluid treatment receptacle 280 from being delivered to the source of process fluid 220 since this fluid in the third conduit 290 can be treated fluid that is to be carefully stored and not mixed with any fluids that could recontaminate the fluid.

The third conduit 290 also includes at least one valve and in particular, the third conduit 290 includes a fourth valve 246 that is located at or near the first end 292 thereof. The fourth valve 246 is thus disposed near the outlet port of the fluid treatment receptacle so that when the fourth valve 246 is closed, the fluid in the fluid treatment receptacle 280 is prevented from flowing into the third conduit 290 and thus, remains in the fluid treatment receptacle 280 as when it is desired for processing the fluid. In contrast, when the fourth valve 246 is opened, the fluid that is within the fluid treatment receptacle 280 is free to flow into the third conduit 290 and then be routed along a desired flow path.

The third conduit intersects the first conduit 230 downstream of the first valve 240 but upstream of the first pump 250 such that operation of the first pump 250 causes the fluid in the third conduit 230 to be drawn into the first conduit 230.

The system 200 can also include a fourth conduit 300 that has a first end 302 that is fluidly connected to a fluid waste receptacle 320 and an opposing second end 304 that is in fluid communication with the first conduit 230. The fourth conduit 300 is thus configured to selectively receive waste fluid from the first conduit 230 generated during the electrode fill cycle. The fourth conduit 300 has a fifth valve 310 associated therein for either permitting fluid communication between the first and third conduits 230, 300 as when the valve 310 is open or preventing fluid communication therebetween as when the valve 310 is closed. The valve 310 is thus preferably located at or near the point where the third conduit 300 is fluidly connected to the first conduit 230. The second pump 260 that is used for recirculation is thus located between the first valve member 240 and the fifth valve member 310.

The location where the fourth conduit 300 is in selective communication with the first conduit 230 is downstream of where the third conduit 290 is in selective communication with the first conduit 230 but is upstream of where the second conduit 270 is in selective communication with the first conduit 230.

A fifth conduit 330 is provided and has a first end 332 that is in communication with a component of the regeneration system (loop) 400, as will be described in greater detail below, and an opposing second end 334 that is in fluid communication with the treated fluid receptacle 380. The fifth conduit 330 thus provides a direct link between a regeneration loop 400 and the receptacle 380 where the treated fluid is stored.

The fifth conduit 330 preferably includes a third pump 340 that is disposed along its length and similar to the other pumps is preferably operably connected and in communication with the master controller such that the third pump 340 can be selectively controlled to cause selective operation and pumping of the fluid that is within the fifth conduit 330. A sixth valve member is disposed in the fifth conduit 330 and operates in the same manner as the other valve members.

A number of control and sensor components can be provided for monitoring different physical characteristics and parameters of the fluid at selected locations along the fluid loop 210. For example, it is desirable to monitor the quality (e.g. chemical properties) of the treated fluid before it is delivered to the storage receptacle 380. The chemical properties of the treated fluid that are monitored will depend upon the particular application and in particular, if the system 200 is being employed for treatment of waste water to remove heavy metals, then the treated water that is discharged from the fluid treatment receptacle 280 is tested for the presence of these heavy metals (e.g., test to see if the heavy metal concentrations are within prescribed limits).

In the illustrated embodiment, the system 200 includes a conductivity sensor 360 and a pH sensor 370 are both located within the third conduit 290 to permit the fluid that is discharged from the fluid treatment receptacle 280 through the third conduit 290 to be monitored before it is delivered into the first conduit 230 for delivery to another location, such as the treated fluid receptacle 380. It will be understood that the sensors 360, 370 can be of a different type depending upon the precise type of fluid treatment.

The present invention also includes the regeneration loop 400 for regenerating the electrodes as described in detail below. Similar to the fluid treatment loop 210, the regeneration loop 400 is in fluid communication with the fluid treatment receptacle 280 in that one end of the loop 400 is associated with an inlet 121 of the fluid treatment tank 280 and the other end of the loop 400 is associated with an outlet 123 of the fluid treatment tank 280. This permits electrode material, as described below, to fluidly flow from the fluid treatment receptacle 280 to the regeneration tank 410.

The regeneration loop 400 includes a first regeneration conduit 420 that has a first end 422 that is fluidly connected to the outlet 123 of the fluid treatment tank 280 and an opposite second end 424 that is in fluid communication with an inlet of a regeneration receptacle (tank) 410. The first regeneration conduit 420 includes a first valve 440 for selectively controlling the flow of the electrode material within the first regeneration conduit 420. The valve 440 can be any number of different types of valves which function to permit flow from the fluid treatment tank 280 to the regeneration tank 410 when the valve 440 is open and prevent the electrode material from flowing from the tank 280 to tank 410 when the valve 440 is closed.

The regeneration tank 410 can includes a number of sensors and operative control mechanisms for maintaining desired regeneration conditions within the regeneration tank 410 to promote regeneration of the electrodes. For example, the regeneration tank 410 can have a heater 412 that is operatively connected to the regeneration tank 410 so that a predetermined temperature can be maintained in the interior of the regeneration tank 410. Any number of different types of heaters 412 can be used so long as they are suitable for the intended uses.

The regeneration tank 410 can also include one or more sensors for monitoring one or more conditions within the interior of the regeneration tank 410. A first sensor 414, such as a pH sensor, can be used to monitor the interior of the regeneration tank 410. It will be appreciated that the first sensor 414 can monitor another parameter besides pH depending upon which parameters should be monitored during the regeneration.

In order to maintain proper regeneration conditions, as described below, a first reagent or substance can be stored at source 416 and is selectively delivered to the regeneration tank 410. According to one embodiment, the source 416 is in the form of a supply of hydrochloric acid or base can be added to the interior of the regeneration tank 410 in order to control and maintain the pH within the regeneration tank 410 in a predetermined range. A second reagent or substance can be stored at source 418 and is selectively delivered to the regeneration 410 at the same time or at a different time that the first reagent or substance is delivered to the regeneration tank 410. The source 418 thus can be in form of an ionic strength adjuster that is contained in the source 416 that is added to the regeneration tank 410

The loop 400 includes a second conduit 430 that has a first end 432 that is attached to an outlet of the regeneration tank 410 and an opposite second end 434 that is fluidly connected to a pressure vessel 490. A second valve 445 is disposed along the second conduit 430 and in one embodiment, the second valve 445 is disposed closer to the first end 432 near where the second conduit 430 is fluidly connected to the regeneration tank 410. As with the other valves, the second valve 445 can be any number of different types of valves, such as a one way valve, that is operable to permit electrode material to flow from the regeneration tank 410 after the electrode material has been regenerated and under operation of the pressure vessel or device 490 when the second valve 445 is opened. Conversely, when the second valve 445 is closed, the electrode material is maintained within the interior of the regeneration tank 410 as when the electrode material is being regenerated.

The regeneration loop 400 is completed by means of a third conduit 450 that includes a first end 452 that is in fluid communication with the pressure vessel 490 and an opposing second end 454 that is in fluid communication with the fluid treatment receptacle 280 for delivering regenerated electrode material to the fluid treatment receptacle 280. The third conduit 450 has a third valve 460 associated therewith and formed along its length to control the flow of the regenerated electrode material within the third conduit 450. The third valve 460 is similar to the other valves and can be any number of one way valves that are suitable for the intended use. In the illustrated embodiment, the third valve 460 is disposed along the third conduit 450 closer to the first end 452 and the pressure vessel 490.

The pressure vessel 490 is in the form of an apparatus that controllably regulates the flow of the electrode material within the regeneration loop 400. In particular, the electrode material is moved within the regeneration loop 400 due to the formation of differences in pressure along the regeneration loop 400. In particular, the electrode material will flow within the regeneration loop 400 to a location of reduced pressure which is caused by operation of the pressure vessel 490.

The pressure vessel 490 can be in the form of a pressure receptacle, such as a tank, that includes an inlet port that is connected to the second end 434 of the second conduit 430 and an outlet port that is connected to the first end 452 of the third conduit 450. The pressure vessel 490 is constructed to generate both negative pressure and positive pressure within and along the regeneration loop 400. In order to generate both negative pressure and positive pressure within the regeneration loop 400, the pressure vessel 490 is associated with a number of operative parts. For example, a source of positive pressure 492, such as an air compressor, can be provided and is operatively connected to the pressure vessel 490 by means of a fluid conduit 493 so as to cause positive pressure to be controllably and selectively exerted on the regeneration loop 400 and in particular on the third conduit 460 so as to force the electrode material within the third conduit 460 to the fluid treatment tank 280. An air compressor (e.g., a pump) is part of the positive pressure source 492 and generates positive pressure within the fluid conduit 493 and the pressure vessel 490 for moving the electrode material within the regeneration loop 400.

A source of negative pressure 470, such as a vacuum device or tank, can be provided and is operatively connected to the pressure vessel 490 by means of a first vacuum line 472. In addition, the vacuum tank 470 can be operatively connected to a vacuum pump 474 that is operated to create negative pressure within a second vacuum line 476 between the vacuum pump 474 and the vacuum tank 470 and the first vacuum line 472 (where is 472). The creation of negative pressure within the pressure vessel 490 permits a negative pressure condition to be formed in the regeneration loop 410 and this permits the electrode material (granular conductive material) to be drawn from the fluid treatment tank 280 once the first and second valves are open. The application of positive pressure by means of the positive pressure source 492 then causes the electrode material to move further along the regeneration loop 400 and into the fluid treatment tank 280.

Once again, the working parts of the regeneration loop 400, such as the valve members and the vacuum pump 474 and the air compressor 492 are preferably operatively connected and in communication with the master controller (processor) to permit the electrode material to flow along a predefined flow path in the regeneration loop 400 depending upon whether the electrode material is being discharged from the fluid treatment tank 280 to the regeneration tank 410 for regeneration of the electrode material or whether the regenerated electrode material is discharged from the regeneration tank 410 and routed back to the fluid treatment tank 280.

The fluid treatment tank 280 contains a number of electrodes 100 that are arranged according to a predetermined pattern within an interior 281 of the fluid treatment tank 280. FIG. 2 shows the components that are placed within the interior 281 of the fluid treatment tank 280 and in particular, shows an arrangement of electrodes 100. More specifically, the fluid treatment tank 280 is defined by a wall structure 283, which in the case of a rectangle is defined by opposing end walls and opposing side walls. The fluid treatment tank 280 includes an upper edge 285 that defines a ceiling or roof that can be closed off using roof plate or the like or it can remain fully open or at least partially open depending upon the application. The fluid treatment tank 280 includes an opposite lower edge 287 that is defined by a floor 289. The one or more inlet ports of the fluid treatment tank 280 are formed along the upper edge 285 and can be formed through the roof plate or the like to permit both receipt of the regenerated electrode material, as described below, as well as receipt of the fluid that is to be treated (e.g., deionized) in the fluid treatment tank 280. The one or more outlet ports of the fluid treatment tank 280 are formed along the floor 289 to permit discharge of both the electrode material that is in need for regeneration and the fluid that has been successfully treated within the fluid treatment tank 280.

The fluid treatment tank 280 is also designed so that each of the second spaces 150 has an associated inlet port 151 for receiving fluid that is to be treated and an associated outlet port 153 that permits the fluid to be discharged from the tank 280. As best shown in FIG. 2, the inlet port 151 can be formed at the upper edge of the tank 280, while the outlet port 153 for each second space 150 can be formed in the floor 289 of the tank 280. As previously mentioned, there are valve members associated with each of the inlet line and the outlet line to permit control over the flow of fluid (e.g., water) into the second spaces 150 and control over the discharge of treated fluid from the tank 280. By having all of the valve members operatively connected to a master controller, all of the valve members can be opened or closed simultaneously to either cause a filling of the tank 280 or a flushing of the tank 280 when the fluid treatment is done in a batch like manner.

Similarly and as illustrated in FIG. 2, each of the members 120 has an inlet port 121 associated therewith for receiving the granular conductive material into the tank 280 and an outlet port 123 associated therewith for discharging the granular conductive material from the tank 280. The inlet port 121 and outlet port 123 are part of the regeneration loop 400 and as with the water loop, the inlet ports 121 and outlet ports 123 have valve members associated therewith to permit selective and controlled delivery of the granular conductive material to the spaces 150 of the tank 280, as well as discharge therefrom when regeneration of the electrode material is needed or desired.

Since the substrate 110 of the electrode 100 is conductive in nature, it is intended to be operatively and electrically connected to the power supply 170 (DC power supply). More specifically, one polarity (+) or (−) of the power supply 170 is connected to the substrate 110 for charging the substrate 110 according to this one polarity. In contrast, the barrier member 130 is formed of a non-conductive material so that it provides a non-conductive interface. Since the granular conductive material 120 abuts and is in direct contact with the substrate 110, along a length thereof, a charge that is delivered to the substrate 110 is also delivered to the granular conductive material 120. In this manner, the electrode material in the form of the granular conductive material 120 is charged as a result of operation of the power supply 170.

As can be seen in FIG. 2, alternating substrates 110 are connected to opposite polarities of the power supply 170 throughout the tank 280. In this manner, the fluid (e.g., water) in the second space or channel 150 is in contact with two electrodes 100 of opposite polarity to permit deionization thereof in one preferred operation using the electrodes 100.

The granular conductive material 120 that forms a part of the electrode assembly 100 has an associated resistance value that is inversely proportional to compression of the granular conductive material 120 by means of the compression device 160 and is directly proportional to the particle size (average particle size) of the granular conductive material 120. In one embodiment, the resistance of the granular conductive material 120, as measured from the first surface 122 adjacent to the conductive substrate 110 to the second surface 124 adjacent to the porous non-conductive barrier member 130, is from about 0.1 milliohm to about 10 ohms. However, it will be appreciated that the above values are merely exemplary and illustrative in nature and is not limiting of the scope of the present invention since the resistance of the granular conductive material 120 may lie outside of this range. It will also be appreciated that the conductivity of the granular conductive material varies depending on a number of different parameters, including the degree of pressure that is being applied to the granular material and the particle size of the granular material.

The width of the second space 150 can vary depending upon the precise application and other factors, such as the size of the tank 280 and the overall fluid processing requirements of the tank 280 per unit of time. According to one embodiment, the width of the second space 150 (and thus the width of the fluid) is between about 0.01 inches and 6.00 inches; however, other widths are equally possible.

The electrical connection between the power supply 170 and the substrates 110 can be accomplished using any number of conventional techniques. Regardless of the exact specifics of the electrode 100, when it is used in a deionization apparatus, the granular conductive material must be supplied with a voltage. This can be done with a rod or wire, such as formed from copper or other conductor that is either attached directly to the substrate 110 or to the granular conductive material 120. However, if the rod or wire is exposed to the liquid being deionized, the rod or wire will be damaged (by being sacrificed). Therefore, a dry connection between the rod or wire and the plate is preferably established.

A dry connection can be made between the substrate 110 of the electrode 100 and a conductor, preferably an insulated copper wire. The wire is then securely attached or connected to the substrate 110 by any number of conventional means, including the use of a solder material or mechanically to a conductive post mounted in the substrate. In order to prevent water from reaching and breaking down the electrical connection, a protective coating is disposed across the substrate 110 to effectively encase the electrical connection. For example, the substrate 110 can be saturated with a marine grade nonconductive epoxy, such as 2-part epoxy resin #2, from Fibre Glass Evercoat, of Cincinnati, Ohio. The nonconductive epoxy 140 seals the region around the copper wire, while not disturbing the preexisting electrical connection between the exposed wire and the substrate 110. It will be appreciated that the protective coating is not limited to the above-mentioned material but rather can be any number of different materials so long as the material can soak into the substrate 110 and not be sacrificial during the operation of the electrode 100. In addition, once the protective coating is applied to the carbon, the protective coating can not change its shape since this could lead to and cause a change of shape of the electrode 100, thereby diminishing the integrity of the electrode 100.

It will be understood that the control system (master controller or processor) can be essentially identical to or similar to the control system that is disclosed in International patent application Serial No. PCT/US2005/38909, which is hereby incorporated by reference in its entirety.

In addition, the system 200 can be designed so that instead of being designed as a batch type fluid treatment process, the system includes staged fluid treatment tanks 280, with the fluid (water) flowing through several stages, with each stage performing partial treatment. The stages can vary in cell spacing (spacing of the electrodes 100) and/or in applied power levels. In addition, the system can be designed so that a continuous flow of fluid (water) through the parallel treatment cells. Also, the fluid (water) can be designed to flow along a serpentine shaped flow path through the treatment cells, two or more of which are arranged in series with one another. The serpentine flow can include variable spacing between the cells (electrodes) and/or different power levels from the beginning to the end of the treatment path.

In addition, the treatment tank 280 can have any number of different geometries, including but not limited to concentric circular layers and spiral-wound layers.

Moreover, while the illustrated embodiment does not include the use of non-absorptive electrodes, it is contemplated that non-absorptive electrodes can be utilized in the system 200 and can be used in combination with the absorptive electrodes 100.

In yet another aspect of the present invention, a process for regenerating the electrode 100 is provided and includes the operation of the regeneration loop 400. After a period of operating time, the granular conductive material will require the removal of the ions that it has captured. The cathode electrode material (negatively charged material) has captured cations, while the anode electrode material (positively charged material) has captured anions. The removal of the respective ions from the granular conductive material is called regeneration.

Regeneration of the electrode material (i.e., granular conductive material) can be accomplished by several methods. For example, one method involves shutting the power of the system off and the ions are allowed to slowly release from both the anion and cation side simultaneously into a static or circulating volume of regenerating fluid. Another method includes reversing the polarity of the electrodes and driving the ions off the electrode material into a regenerating fluid. This process also includes selective regeneration against a non-absorptive material electrode. Another method includes using chemicals to alter the solution equilibrium and ionic solubility to drive ions from the electrode material into solution complexes. Moreover, any combination of the above methods is also suitable for use as a regeneration method.

One preferred method for regenerating the electrode material (granular conductive material) includes the following steps. The regeneration method can be thought of as performing two different operations, namely, removal of cations from the negatively charged granular conductive material and removal of the anions from the positively charged granular conductive material.

The removal of cations from the negatively charged electrode material involves removal of the negatively charged electrode material (negatively charged granular conductive material) from the system, keeping it separate from the positively charged electrode material (positively charged granular conductive material). This step can be accomplished by several methods. For example, the electrode material is sluiced from the electrode housing (tank 280) into a separate containment vessel (tank 410) using the systems process treated water. After the cathode electrode material, with its captured cations, is in the containment vessel (tank 410), it may be necessary to add a small amount of acid to dissolve any hydroxide complexed cations that may have deposited on the anion electrode material. The amount of acid used is only to dissolve complexed cation hydroxide precipitates. One preferred acid is hydrochloric, however, acetic, citric, nitric, sulfuric, and phosphoric acids can be used. It is also possible to generate adequate amounts of acid internal to the cell by adjusting the ratio of anion to cation ICM.

A pH of 2.0 to 6.0 is maintained. The solution is mixed for a predetermined time period, e.g., approximately 5 to 40 minutes or until the desired reactions have occurred. The volume of liquid covering the electrode material should be a minimum so that excessive acid is not needed to adjust the pH to less than 3.0. After the acid has reacted the resulting liquid is drained from the cathode electrode material.

Draining the acid solution from the cathode electrode material after the 5 to 40 minute contact time can be accomplished by several methods, such as the use of vacuum filtration, filtration through an acid resistant material and centrifugal separation. One preferred technique for accomplishing this includes the withdrawal of the liquid by use of a porous plate and a vacuum source.

The regeneration process also involves the removal of the anions from the positively charged electrode material. This can include the steps of removing the slurry such that the positively charged electrode material which has a low pH is added to the previously drained negatively charged material in the regeneration vessel. This acidic solution is used to release the remaining anions from the electrode material. This solution can be used at full strength or it can be drained off or diluted to a specific concentration. One preferred method is to use only a portion of the acidic liquid solution to release the remaining anions. The negatively charged electrode material is added to the acidic positively charged electrode material mixture. The combined mixture is brought to a volume with process water (DI) and then slowly stirred. Depending on the ions present, the solution may require heating as high as 100° C.; however, this will depend on a number of parameters, such as the specific ions present and therefore could be less or even greater than this value. It has also been determined that other chemicals can be added to accelerate the release of the anions including sodium hydroxide, ammonium hydroxide, sodium carbonate and others.

After the desired reaction time, the liquid is drawn off the combined electrode material (mixture) using the porous plate and vacuum technique. The resulting mixed material is drained and then placed back into the electrode housing (tank 280) and placed back into operation.

### EXAMPLE

According to one embodiment, the process stream that is delivered to the fluid treatment tank 280 is a stream of waste fluid from a manufacturing or processing plant. As is well known, process streams from these facilities have unacceptable concentrations of heavy metals, i.e. nickel, chromium, mercury, cadmium, zinc and lead ions, which need to be removed before the process stream can be discharged into the environment. The present invention provides an effective and easy manner of deionizing the process streams to remove the ions, which are later collected during the regeneration process once the granular conductive material is regenerated and the captured/absorbed ions are removed from this material.

### Example 1

It will also be appreciated that the electrode and deionization system and regeneration system can be employed in any number of other applications, such as a general water treatment plant or a toxic waste treatment facility, where ions, such as nickel, mercury, cadmium, etc., can be removed. However, these ions are merely exemplary of the types of ions that can be removed from the process stream. It is also contemplated, that nuclear waste water can be processed due to the absorption of radioisotopes on the respective electrode surfaces (granular conductive material) the accumulated waste can be collected and reclaimed or discarded (e.g., forming concentrated solid plates collected from the operation process).

### Example 2

In yet another aspect of the present invention, the electrode and deionization system described herein is suitable not only for the removal and extraction of inorganic materials but also can be used to remove and extract organic materials, such as proteins and other organic materials that are commonly found in effluent streams. In other words, the present invention relates to both organic and inorganic ions including proteins, biopolymers and organic molecules that carry a charge. The present invention relates both to the removal of impurities (organic and inorganic) from a process stream as well as the concentration of charged molecules (organic and inorganic) on the electrode material.

For example, a process for removing organic material from a stream can include the steps of providing the organic impurities that can be ionized; ionizing the organic impurities to form organic ions by arranging a plurality of first and second electrodes. Each electrode includes: (a) a conductive material that is in a granular form and is arranged in a layer that is defined by a first face and a second face; (b) a substrate that is disposed against the first face; and (c) a first member that is disposed against the second face and is formed to permit a fluid to be treated to pass through the first member and into contact with the granular conductive material. The process further includes positively charging the first electrodes and negatively charging the second electrodes; and flowing the fluid containing the organic impurities within a space between the first members of adjacent first and second electrodes resulting in the fluid passing through the first member and into contact with the granular conductive material associated with the first and second electrodes. The present invention yields excellent results so long as the organics can be ionized and thus separated by the present electrode.

For example, the present electrode and deionization system can be used in pharmaceutical and biotech applications and settings where organic compounds are prevalent and there is a need and desire to remove and isolate such organics.

In addition, the present invention can optionally include a barrier membrane between the process stream and the electrode material for the separation or exclusion of molecules (e.g., organics).

What is claimed is:

1. An electrode for use in a deionization apparatus comprising:
a conductive material that is in a granular form and is arranged in a layer that is defined by a first face and a second face;
a substrate that is disposed against the first face; and
a first member that is disposed against the second face and is formed to permit a fluid to be treated to pass through the first member and into contact with the granular conductive material.

2. The electrode of claim 1, wherein the granular conductive material comprises:
a polymerization monomer;
a crosslinker; and
a catalyst; and
or reaction products thereof, together in a carbonized form, that is processed into a plurality of particles.

3. The electrode of claim 2, wherein the polymerization monomer comprises at least one material from the group consisting of dihydroxy benzenes; trihydroxy benzenes; dihydroxy naphthalenes and trihydroxy naphthalenes, furfural alcohol and mixtures thereof.

4. The electrode of claim 1, wherein the substrate is formed of a conductive material.

5. The electrode of claim 4, wherein the substrate comprises an electrically conductive plate.

6. The electrode of claim 1, wherein the substrate is formed of a material that is selected from the group consisting of graphite, electrically conductive steel, conductive polymers and electrically conductive non-ferrous metals.

7. The electrode of claim 1, wherein the granular conductive material is under compression between the substrate and the first member.

8. The electrode of claim 1, wherein the granular conductive material has a bulk resistance that is between about 0.1 milliohm to about 10 ohms.

9. The electrode of claim 1, wherein a width of the layer of granular conductive material is greater than a width of both the substrate and the first member.

10. The electrode of claim 1, wherein the granular conductive material has a particle size between about 40 microns and about 120 microns.

11. The electrode of claim 1, wherein the granular conductive material has a pore diameter that is in the range from about 10 A to about 100A by BET or 0.0100 um to 3000 um by mercury penetrometer and a surface area between about 100 to about 1200 m²/g (BET).

12. The electrode of claim 1, wherein the first member comprises a structure formed of a porous material that permits the fluid to flow therethrough and into contact with the granular conductive material.

13. The electrode of claim 12, wherein a pore size of the porous material is less than an average particle size of the granular conductive material so as to prevent the granular conductive material from passing therethrough.

14. The electrode of claim 1, wherein the first member comprises a structure that has a plurality of through openings formed therein to permit the fluid to flow therethrough and into contact with the granular conductive material.

15. The electrode of claim 14, wherein the structure of the first member has a grid construction.

16. The electrode of claim 1, wherein the first member is formed of a non-conductive material.

17. A system for deionization of a fluid comprising:
a treatment tank; and
a plurality of electrodes according to claim 1 arranged within an interior of the treatment tank such that at least some of the electrodes are arranged with the substrates of adjacent electrodes facing one another and at least some of the electrodes are arranged with the first members facing one another but spaced apart so as to define a first space therebetween which receives the fluid to be deionized.

18. The system of claim 17, wherein the granular conductive material is in the form of loose particles that are held under compression in an operating mode of the system.

19. The system of claim 17, wherein each of the electrodes has a first inlet conduit for delivering the fluid into the first space and a first outlet conduit for discharging the fluid from the first space and a second inlet conduit for delivering granular conductive material to a location between the substrate and first member and a second outlet conduit for removing the granular conductive material.

20. The system of claim 17, wherein granular conductive material is placed under compression in an operating mode, with the compression being removed in a regeneration mode to permit the granular conductive material to flow viscously through the second outlet conduit, while the substrate and first member remain upstanding and spaced apart in the interior of the tank.

21. The system of claim 17, further including:
a power supply having a positive polarity and a negative polarity, wherein substrates of alternating electrodes are electrically connected to opposite polarities of the power supply so as to create a voltage potential across the first space.

22. The system of claim 17, wherein a second space is formed between the at least some of the substrates that face one another and an inflatable member is disposed within the second space for selectively applying pressure to the substrates to cause the respective layers of granular conductive material to be placed under compression when the inflatable member is inflated.

23. The system of claim 22, wherein the inflatable member is in the form of an inflatable bladder that extends along a substantial length of the substrate, wherein when inflated, the bladder applies a force to two spaced substrates and in turn, compression of the granular conductive material of the electrodes results.

24. The system of claim 17, further including:
a first fluid circuit for selectively delivering a process stream into the first spaces defined in the interior of the tank and selectively discharging the process stream after deionization thereof;
a second fluid circuit for selectively delivering the granular conductive material to a location between the substrate and first member of each electrode and for selectively removing positively and negatively charged granular conductive material from the fluid treatment tank for regeneration thereof.

25. The system of claim 24, wherein the second fluid circuit includes a regeneration tank that is maintained at predetermined conditions to permit regeneration of the granular conductive material by removal of charged ions attached to the positively and negatively charged granular conductive material.

26. The system of claim 25, further including:
a source of acid that is fluidly connected to the regeneration tank for selective delivery thereto;
a source of base (optional chemical ionic strength modifier) that is fluidly connected to the regeneration tank for selective delivery thereto;
a pH sensor for measuring a pH of the material within the regeneration tank and a heater for controlling a temperature within the regeneration tank; and
a master controller in communication with the sources of acid and base, the pH sensor and the heater to permit conditions within the regeneration tank to be controlled and maintained within a predetermined operating range.

27. The system of claim 24, further including:
means for moving the granular conductive material along the second fluid circuit from the treatment tank to the regeneration tank and then back to the treatment tank.

28. The system of claim 27, wherein the means operates by creating a pressure differential within the second fluid circuit for causing the controlled movement of the granular conductive material from one location to another location.

29. The system of claim 28, wherein the granular conductive material is part of a slurry that is moved along the second fluid circuit by operation of the means.

30. The system of claim 28, wherein the means includes a first device that creates positive pressure within the second fluid circuit and a vacuum device that creates negative pressure within the second fluid circuit.

31. The system of claim 24, wherein the first fluid circuit includes a first receptacle for holding the process stream that is to be deionized, a second receptacle that receives waste water and a third receptacle that receives deionized water, each of the first, second and third receptacles being fluidly connected to the treatment tank and including as associated valve member for selectively controlling flow of the process stream and the flow of waste water and deionized water from the treatment tank.

32. A process for forming an electrode comprising the steps of:
providing a first member and a second member;
forming a granular conductive material; and
disposing and containing the granular conductive material, in a loose particle form, between the first and second members, wherein the second member is constructed to permit fluid to pass therethrough into contact with the granular conductive material.

33. The process of claim 32, wherein the first member comprises a conductive plate and the second member is one of a layer of porous material and a perforated structure.

34. The process of claim 32, wherein the step of forming the granular conductive material comprises the steps of:
dissolving at least one polymerization monomer in a first crosslinker to form a first liquor;
maintaining the first liquor for a sufficient time and at a sufficient temperature until the first liquor forms a partially reacted 1 precurser polymer;
mixing the partially reacted liquor with a second crosslinker to form a mixed second liquor and maintaining the mixed second liquor for a sufficient time and at a sufficient temperature until the mixed second liquor polymerizes into a first solid blank;
firing the first solid blank at a sufficient temperature and for a sufficient time such that the first solid blank carbonizes into an electrically conductive member; and
processing the first solid blank, after the first block cools, so as to break up the carbonized blank into a granular carbon material;

35. The process of claim 34, wherein the polymerization monomer is selected from the group consisting of dihydroxy benzenes, dihydroxy napthalenes, trihydroxy benzenes and trihydroxy napthalenes, furfural alcohol and mixtures thereof.

36. The process of claim 34, wherein the first crosslinker and the second crosslinker are formaldehyde.

37. The process of claim 34, wherein the step of processing the first solid blank comprises the step of:
pulverizing the carbonized blank into the granular carbon material.

38. The process of claim 32, further including the step of:
compressing the granular conductive material between the first and second members.

39. The process of claim 38, wherein the step of compressing the granular conductive material includes the steps of:
forming a first space between the first members of adjacent electrodes;
inserting an inflatable member within the first space along the first members; and
inflating the inflatable member to cause compression of the granular conductive material.

40. A method of deionization of a fluid comprising the steps of:
arranging a plurality of first and second electrodes according to claim 1 within a fluid treatment structure;
positively charging the first electrodes and negatively charging the second electrodes; and
flowing the fluid within a space between the first members of adjacent first and second electrodes resulting in the fluid passing through the first member and into contact with the granular conductive material associated with the first and second electrodes.

41. A method of regenerating oppositely charged electrodes, each electrode being formed of a conductive material that is in a granular form and is arranged in a layer, a substrate that is disposed against the layer, and a first member that is disposed against the layer and is formed to permit a fluid to pass through the first member and into contact with the granular conductive material, the method comprising the steps of:
forming a first slurry that includes negatively charged granular conductive material and a fluid and placing it into a first receptacle,
processing the first slurry to cause removal of cations from the negatively charged granular conductive material;
draining the first slurry after cation removal;
forming a second slurry that includes positively charged granular conductive material and a fluid and placing it into the first receptacle;
draining the second slurry through the first slurry to form combined slurries;
adding process water to the combined slurries;
heating and mixing the combined slurries for a period of time to form a mixed slurry;
draining the mixed slurry of all fluid;
adding treated water to the mixed slurry;
heating and mixing the mixed slurry for a period of time;
draining the mixed slurry of all water and transferring it to a pressure vessel to await return to the electrode.

42. The method of claim 41, further including the steps of:
adding an acid to the first slurry to form a first solution that has a pH within a predetermined range; and
draining the first solution after the acid has reacted and prior to adding the second slurry to the first slurry.

43. The method of claim 42, wherein the acid comprises hydrochloric acid and the pH of the first slurry is maintained between 2.3 to 3.8 for between about 10 to 45 minutes.

44. The method of claim 41, wherein a temperature of the mixed slurries is maintained between ambient and 100 degrees centigrade for a duration of between about 1 to 8 hours.

45. The method of claim 41, wherein the first and second slurries are drained after heating.

46. The method of claim 41, wherein the treated water is added to the first and second mixture and heated and mixed for between about 1 to about 8 hours and the mixed first and second slurries are drained after heating.

47. A method of deionization of a fluid containing organics comprising the steps of:
arranging a plurality of first and second electrodes according to claim 1 within a fluid treatment structure;
positively charging the first electrodes and negatively charging the second electrodes; and
flowing the fluid within a space between the first members of adjacent first and second electrodes resulting in the fluid passing through the first member and into contact with the granular conductive material associated with the first and second electrodes to cause ionization and removal of the organics.

48. The method of claim 47, wherein the organics are selecting from the group consisting of proteins, biopolymers and organic molecules that can carry a charge.
